(19) United States
(12) Patent Application Publication
(10) Pub. No.: US 2017/0054145 A1
(43) Pub. Date: Feb. 23, 2017

(54) LITHIUM ION SECONDARY BATTERY AND METHOD OF PRODUCING SAME

(71) Applicant: TOYOTA JIDOSHA KABUSHIKI KAISHA, Toyota-shi (JP)

(72) Inventors: Machiko ABE, Okazaki-shi (JP); Kosuke IWASE, Nagoya-shi (JP); Masahiro YOSHIOKA, Toyota-shi (JP)

(73) Assignee: TOYOTA JIDOSHA KABUSHIKI KAISHA, Toyota-shi (JP)

(21) Appl. No.: 15/236,662

(22) Filed: Aug. 15, 2016

(30) Foreign Application Priority Data
Aug. 21, 2015 (JP) 2015-164129

(51) Int. Cl. H01M 4/36; H01M 10/44; H01M 10/0568; H01M 10/0525; H01M 10/0569

(52) U.S. Cl. CPC H01M 4/366; H01M 10/0525; H01M 10/0569; H01M 10/0568; H01M 10/446; H01M 2004/027

(57) ABSTRACT

A lithium ion secondary battery is provided that is resistant to a decline in capacity even when subjected to repeated charge/discharge under conditions that facilitate the precipitation of lithium metal on a negative electrode surface. The herein disclosed lithium ion secondary battery has: an electrode assembly having a positive electrode and a negative electrode; and a nonaqueous electrolyte solution containing a carbonate solvent and LiPF₆. A surface of the negative electrode is coated with granules each having an approximately circular base. The granules contain element hydrogen, element carbon, element oxygen, element fluorine, and element phosphorus. The average diameter of the bases of the granules is 54 nm to 158 nm.

### BACKGROUND OF THE INVENTION

1. Field of the Invention

The present teaching relates to a lithium ion secondary battery and to a method of producing the battery. This application claims priority based on Japanese Patent Application No. 2015-164129 filed Aug. 21, 2015, and the contents of this application are incorporated in their entirety in the present specification by reference.

2. Description of the Related Art

Lithium ion secondary batteries are lighter and have a higher energy density than older batteries and in recent years have been used as so-called portable power sources for personal computers, portable devices, and so forth, and as a vehicle drive power source. In particular, lithium ion secondary batteries are expected to become increasingly popular in the future as high-output drive power sources for vehicles such as electric vehicles (EV), hybrid vehicles (HV), and plug-in hybrid vehicles (PHV).

In order to improve, inter alia, the cycle life of lithium ion secondary batteries, an initial charging is carried out on a lithium ion secondary battery in order to form a passive coating film known as a solid electrolyte interface (SEI) film on the surface of the negative electrode. This coating film suppresses decomposition of the nonaqueous electrolyte solution and also makes possible a smooth insertion and release of the lithium ion.

With regard to the initial charging of lithium ion secondary batteries, Japanese Patent Application Laid-open No. 2002-280080 teaches that the execution of the initial charging of a lithium ion secondary battery at a current of not more than 0.8 C provides a higher discharge capacity retention ratio after 100 charge/discharge cycles than does the execution of the initial charging at a current of 1.0 C or more.

### SUMMARY OF THE INVENTION

However, as a result of investigations by the present inventors, it was discovered that a nonuniform formation of the coating film on the negative electrode surface was readily produced in a lithium ion secondary battery that was subjected to an initial charging at a current of not more than 0.8 C as taught in Japanese Patent Application Laid-open No. 2002-280080. It was also discovered that the capacity of this lithium ion secondary battery readily declines when it is subjected to repeated charge/discharge under conditions that facilitate the precipitation of lithium metal on the negative electrode surface.

An object of the present teaching is therefore to provide a lithium ion secondary battery that is resistant to a decline in capacity even when subjected to repeated charge/discharge under conditions that facilitate the precipitation of lithium metal on the negative electrode surface.

The herein disclosed lithium ion secondary battery is provided with: an electrode assembly having a positive electrode and a negative electrode; and a nonaqueous electrolyte solution containing a carbonate solvent and LiPF₆. A surface of the negative electrode is coated with granules each having an approximately circular base. These granules contain element hydrogen, element carbon, element oxygen, element fluorine, and element phosphorus. The average diameter of the bases of these granules is 54 nm to 158 nm.

This construction is resistant to a decline in capacity even when repeated charge/discharge is performed under conditions that facilitate the precipitation of lithium metal on the negative electrode surface. Charge/discharge under conditions that facilitate the precipitation of lithium metal on the negative electrode surface can be exemplified by charge/discharge under the following conditions: pulse charge for 5 seconds at −10° C. at a constant current of 25 C; pause for 5 minutes; then pulse discharge for 5 seconds at a constant current of 25 C; and pause for 5 minutes.

A herein disclosed method of producing a lithium ion secondary battery is a method for producing the above-described lithium ion secondary battery. The method includes: fabricating a lithium ion secondary battery assembly including an electrode assembly having a positive electrode and a negative electrode and also including a nonaqueous electrolyte solution containing a carbonate solvent, LiPF₆, and LiPF₂(C₂O₄)₂; and subjecting the lithium ion secondary battery assembly to initial charging at a current of 0.026 C to 0.78 C.

The lithium ion secondary battery obtained by this production method is resistant to a decline in the capacity even when repeated charge/discharge is performed under conditions that facilitate the precipitation of lithium metal on the negative electrode surface.

### BRIEF DESCRIPTION OF THE DRAWINGS

FIG. 1 is a cross-sectional diagram that schematically shows the internal structure of a lithium ion secondary battery according to an embodiment of the present teaching;

FIG. 2 is a schematic diagram that shows the structure of the wound electrode assembly of a lithium ion secondary battery according to an embodiment of the present teaching;

FIG. 3A is a schematic diagram of a negative electrode on which a coating film is uniformly formed; FIG. 3B is a schematic diagram of a negative electrode covered with granules each having an approximately circular base for which the average diameter is in the range from 54 nm to 158 nm; and FIG. 3C is a schematic diagram of a negative electrode covered with granules each having an approximately circular base for which the average diameter exceeds 158 nm;

FIG. 4 is a TEM photograph for measuring the average diameter of the approximately circular bases of the granules on the negative electrode of lithium ion secondary battery No. 8; and

FIG. 5 is a graph that shows the relationship between the capacity retention ratio and the average diameter of the approximately circular bases of the granules on the negative electrode for the lithium ion secondary batteries No. 1 to No. 8 under consideration.

### DESCRIPTION OF THE PREFERRED EMBODIMENTS

Embodiments according to the present teaching are described in the following with reference to the drawings. Matters required for the execution of the present teaching but not particularly described in the present specification (for example, the general structure and production process of and for lithium ion secondary batteries, that are not characteristic features of the present teaching) can be understood as design matters for those skilled in the art based on the conventional art in the pertinent field. The present teaching can be implemented based on the contents disclosed in the present specification and the common general technical knowledge in the pertinent field. In addition, in the following description of the drawings, members and positions that exercise the same function are assigned the same reference symbol. Moreover, the dimensional relationships (length, width, thickness, and so forth) in the individual drawings do not reflect actual dimensional relationships.

In the present specification, “secondary battery” refers generally to a storage device that is capable of repeated charging and discharge and is a term that includes so-called storage batteries, e.g., lithium ion secondary batteries, as well as storage devices such as electric double-layer capacitors. In the present specification, “lithium ion secondary battery” refers to a secondary battery that utilizes the lithium ion as its charge carrier and that realizes charge/discharge by the transfer between the positive and negative electrodes of the charge associated with the lithium ion.

The present teaching is described in detail herebelow using a flat prismatic lithium ion secondary battery as an example, but this does not mean that the present teaching is limited to or by that which is described in this embodiment.

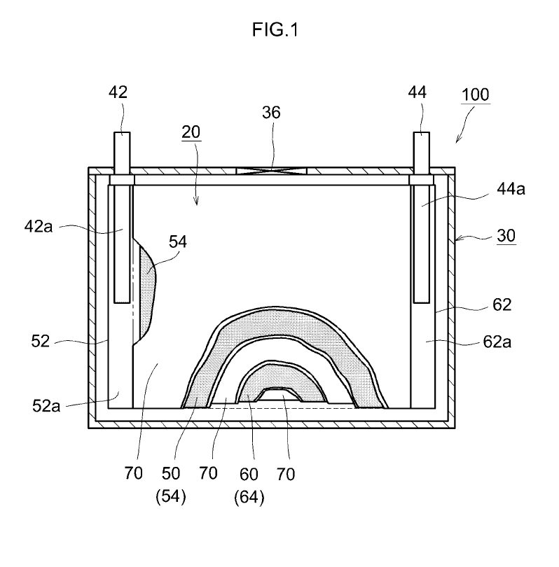

The lithium ion secondary battery 100 shown in FIG. 1 is a sealed lithium ion secondary battery 100 fabricated by housing a flat wound electrode assembly 20 and a nonaqueous electrolyte solution (not shown) in a flat prismatic battery case (i.e., an outer container) 30. The following are disposed in the battery case 30: a positive electrode terminal 42 and a negative electrode terminal 44 for making external connections, and a thin-walled safety valve 36 set to release the internal pressure when the internal pressure in the battery case 30 rises to or exceeds a set level. A fill port (not shown) is also disposed in the battery case 30 for the purpose of filling with the nonaqueous electrolyte solution. The positive electrode terminal 42 is electrically connected to a positive electrode current collector plate 42a. The negative electrode terminal 44 is electrically connected to a negative electrode current collector plate 44a. For example, a lightweight metal having a good thermal conductivity, e.g., aluminum, can be used for the material of the battery case 30.

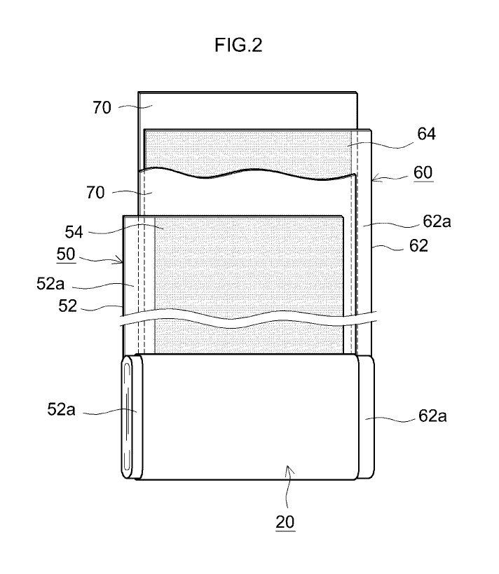

As shown in FIGS. 1 and 2, the wound electrode assembly 20 has a configuration in which a positive electrode sheet 50 and a negative electrode sheet 60 are stacked together and wound in the length direction with two long strip-shaped separator sheets 70 interposed therebetween, wherein the positive electrode sheet 50 has a positive electrode active material layer 54 formed along the length direction on one side or both sides (both sides in this instance) of a long strip-shaped positive electrode current collector 52, and the negative electrode sheet 60 has a negative electrode active material layer 64 formed along the length direction on one side or both sides (both sides in this instance) of a long strip-shaped negative electrode current collector 62. The positive electrode current collector plate 42a and the negative electrode current collector plate 44a are connected to, respectively, a positive electrode active material layer-free region 52a (that is, a region where the positive electrode active material layer 54 is not formed and the positive electrode current collector 52 is thereby exposed) and a negative electrode active material layer-free region 62a (that is, a region where the negative electrode active material layer 64 is not formed and the negative electrode current collector 62 is thereby exposed), which are formed so as to extend to the outside from the two ends considered in the direction of the winding axis (refers to the direction of the sheet width that is orthogonal to the aforementioned length direction) of the wound electrode assembly 20.

The positive electrode current collector 52 constituting the positive electrode sheet 50 can be, for example, aluminum foil. The positive electrode active material contained in the positive electrode active material layer 54 can be exemplified by lithium transition metal oxides (for example, LiNi_{1/3}Co_{1/3}Mn_{1/3}O₂, LiNiO₂, LiCoO₂, LiFeO₂, LiMn₂O₄, LiNi_{0.5}Mn_{1.5}O₄, and so forth) and by lithium transition metal phosphate compounds (for example, LiFePO₄ and so forth). The positive electrode active material layer 54 may contain a component other than the active material, for example, a conductive material, a binder, and so forth. For the conductive material, a carbon black, e.g., acetylene black (AB), or another carbon material (for example, graphite) can be suitably used. For example, polyvinylidene fluoride (PVDF) can be used for the binder.

The negative electrode current collector 62 constituting the negative electrode sheet 60 can be, for example, copper foil. For example, a carbon material such as graphite, hard carbon, soft carbon, and so forth can be used for the negative electrode active material contained in the negative electrode active material layer 64. The negative electrode active material layer 64 may contain a component other than the active material, for example, a binder, a thickener, and so forth. Styrene-butadiene rubber (SBR) and so forth can be used for the binder. For example, carboxymethyl cellulose (CMC) and so forth can be used for the thickener.

In the present embodiment, the surface of the negative electrode sheet 60 (particularly the negative electrode active material layer 64) is coated with granules each having an approximately circular base. These granules contain the element hydrogen, the element carbon, the element oxygen, the element fluorine, and the element phosphorus. The average diameter of the approximately circular bases of these granules is 54 nm to 158 nm.

As noted above, when the initial charging of a lithium ion secondary battery has in the past been carried out at a current of not more than 0.8 C, a nonuniform formation of the coating film (the SEI film) formed on the surface of the negative electrode has readily occurred. When a lithium ion secondary battery is subjected to repeated charge/discharge after its initial charge, this nonuniform formation creates the concern that lithium metal will precipitate on the surface of the negative electrode. The capacity of a lithium ion secondary battery is reduced when lithium metal precipitates on the surface of the negative electrode. However, by controlling the nonuniform formation of the coating film (the SEI film), the coating film component is produced in this embodiment in the form of the granules described above and the surface of the negative electrode sheet 60 (particularly the negative electrode active material layer 64) is coated with these granules. This construction inhibits the occurrence of a decline in the capacity of the lithium ion secondary battery even after its repeated charge/discharge under conditions that facilitate the production of lithium metal on the negative electrode (for example, even after repeated charge/discharge under the following conditions: pulse charge for 5 seconds at −10° C. at a constant current of 25 C, followed by pulse discharge for 5 seconds at a constant current of 25 C).

These granules typically have an approximately partial spherical shape and are provided with an approximately circular base. This approximately partial spherical shape typically refers to a shape provided by sectioning a sphere or ellipsoid at some plane. In addition, the approximately circular base is a circular or ellipsoidal base and, for example, refers to a shape in which the difference between its longest diameter and shortest diameter is not more than 30% of the longest diameter (desirably not more than 15%). Moreover, the base of the granule denotes the side in contact with the negative electrode.

These granules are provided by the formation in a novel configuration of the coating film (the SEI film) that forms on the negative electrode of a conventional lithium ion secondary battery, and thus these granules contain element hydrogen, element carbon, element oxygen, element fluorine, and element phosphorus that are components of the coating film. These elements are thought to originate with the carbonate solvent, LiPF₆, and LiPF₂(C₂O₄)₂, vide infra. The presence of these elements in the granules can be confirmed, for example, by TEM-EELS analysis, which combines transmission electron microscopy (TEM) with electron energy loss spectroscopy (EELS).

The bases of the granules have an approximately circular shape and the average diameter is 54 nm to 158 nm. As shown by the experimental data in the examples below, when the average diameter is in the range from 54 nm to 158 nm, the lithium ion secondary battery 100 is resistant to a decline in its capacity even after repeated charge/discharge under conditions that facilitate the production of lithium metal on the negative electrode 60. The average diameter of the approximately circular bases of the granules can be determined by preparing a cross-sectional sample of the negative electrode 60 by air-isolated FIB; taking a photograph using a transmission electron microscope (TEM); and measuring the diameter of the approximately circular bases of at least 30 granules and determining the average value thereof.

It is not necessary for the granules to cover the entire surface of the negative electrode 60 (particularly the negative electrode active material layer 64). That is, a region where the granules are not attached may be present on the negative electrode 60. For example, the negative electrode 60 may be coated by the granules present scattered in an island configuration. A layer-shaped coating film containing element hydrogen, element carbon, element oxygen, element fluorine, and element phosphorus may be formed in the regions where the granules are not attached on the negative electron 60.

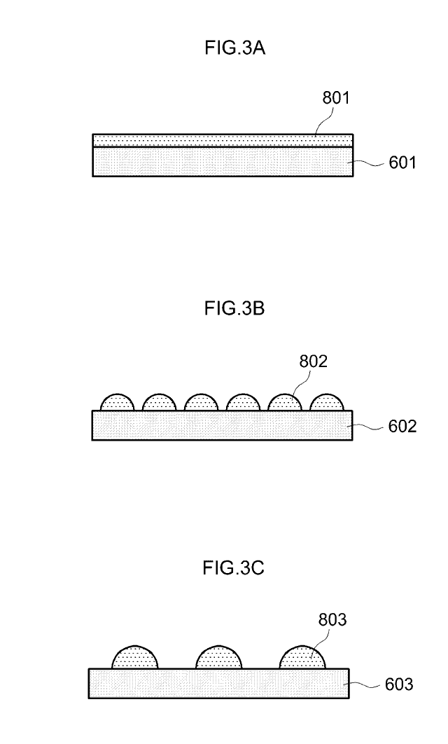

The following is hypothesized for the reason why the coating of the negative electrode 60 with the granules makes the lithium ion secondary battery 100 resistant to a decline in its capacity even after repeated charge/discharge under conditions that facilitate the production of lithium metal on the negative electrode 60. FIG. 3A shows the case in which a coating film 801 is uniformly formed on a negative electrode 601. The interface between the coating film 801 and the negative electrode 601 is large when as shown in FIG. 3A the coating film 801 is formed uniformly on the negative electrode 601. The result is thought to be that the precipitation of lithium metal then readily occurs. FIG. 3B shows the case in which a negative electrode 602 is coated with granules 802 that have an approximately circular base for which the average diameter is in the range from 54 nm to 158 nm. In this case, the interface between the granule 802, which is the coating component, and the negative electrode 602 is small and the area of the region where the negative electrode 602 is not coated by the granules 802 is narrow. It is thought that the precipitation of lithium metal is suppressed as a result. FIG. 3C shows the case in which a negative electrode 603 is coated with granules 803 that have an approximately circular base for which the average diameter exceeds 158 nm. In this case, the area of the region where the negative electrode 603 is not coated by the granules 803 is broad. It is thought that the precipitation of lithium metal is facilitated as a result.

In addition, it is thought that, in comparison to the case in which the coating film 801 is uniformly coated on the negative electrode 601 as shown in FIG. 3A, increases in the resistance are suppressed to a greater degree in the case in which the negative electrode 602 is coated with the granules 802 as shown in FIG. 3B. This is due to the small interface between the negative electrode 602 and the granule 802 that is the coating component.

The method for producing a lithium ion secondary battery 100 in which the negative electrode 60 is coated with the aforementioned granules in this manner is described later.

The separator 70 can be exemplified by a porous sheet (film) made from a resin such as polyethylene (PE), polypropylene (PP), polyester, cellulose, polyamide, and so forth. This porous sheet may have a single layer structure or may have a laminate structure of two or more layers (for example, a three layer structure in which PP layers are laminated on both sides of a PE layer). A heat-resistant layer (HRL) may be disposed at a surface of the separator 70.

The nonaqueous electrolyte solution contains a carbonate solvent as a nonaqueous solvent and LiPF₆ as a supporting salt. The carbonate solvent can be exemplified by ethylene carbonate (EC), propylene carbonate (PC), diethyl carbonate (DEC), dimethyl carbonate (DMC), and ethyl methyl carbonate (EMC). A single such nonaqueous solvent can be used by itself or a suitable combination of two or more can be used. The concentration of the supporting salt is desirably at least 0.7 mol/L and not more than 1.3 mol/L.

Insofar as the effects of the present teaching are not significantly impaired, the nonaqueous electrolyte solution may contain a nonaqueous solvent other than a carbonate solvent, a supporting salt other than LiPF₆, an additive, and so forth.

An advantageous method of producing the aforementioned lithium ion secondary battery 100 is described in the following. This advantageous method includes a step (the first step) of fabricating a lithium ion secondary battery assembly that has an electrode assembly 20 having a positive electrode 50 and a negative electrode 60 and that has a nonaqueous electrolyte solution containing a carbonate solvent, LiPF₆, and LiPF₂(C₂O₄)₂, and a step (the second step) of subjecting the lithium ion secondary battery assembly to initial charging at a current of 0.026 C to 0.78 C.

The first step will be described first. The electrode assembly 20 having a positive electrode 50 and a negative electrode 60 can be fabricated according to ordinary methods. Specifically, the positive electrode sheet 50 and the negative electrode sheet 60 are fabricated first.

The positive electrode sheet 50 can be fabricated by preparing a positive electrode paste (this includes positive electrode slurries and positive electrode inks) by mixing the positive electrode active material, a conductive material, a binder, and so forth in a suitable solvent (for example, N-methyl-2-pyrrolidone); coating this positive electrode paste on one side or both sides of the positive electrode current collector 52; and drying. A suitable pressing treatment may be executed on the positive electrode sheet 50 after drying.

The negative electrode sheet 60 can be fabricated by preparing a negative electrode paste (this includes negative electrode slurries and negative electrode inks) by mixing a negative electrode active material, a binder, and so forth in a suitable solvent (for example, water); coating this negative electrode paste on one side or both sides of the negative electrode current collector 62; and drying. A suitable pressing treatment may be executed on the negative electrode sheet 60 after drying.

The electrode assembly (wound electrode assembly) 20 can be obtained by fabricating a layered assembly by stacking the thusly obtained positive electrode sheet 50 and negative electrode sheet 60 with two separators 70 interposed therebetween; winding this in the length direction; and flattening by pressing from the side direction. The electrode assembly 20 may also be fabricated by winding the layered assembly itself so that its wound cross section assumes a flat shape.

The electrode assembly 20 is then housed in the battery case 30 using a known method. Specifically, an opening-equipped main body for the battery case 30 and a lid for the battery case 30, the lid having a fill port for the nonaqueous electrolyte solution, are prepared. The lid has dimensions that can close the opening in the main body of the battery case 30. The positive electrode terminal 42 and the positive electrode current collector plate 42a as well as the negative electrode terminal 44 and the negative electrode current collector plate 44a are attached to the lid of the battery case 30. The positive electrode current collector plate 42a and the negative electrode current collector plate 44a are welded, respectively, to the positive electrode current collector 52 and the negative electrode current collector 62 that are exposed at the ends of the wound electrode assembly 20. The wound electrode assembly 20 is inserted into the interior of the battery case 30 through the opening in the main body, and the lid is welded to the main body of the battery case 30.

The nonaqueous electrolyte solution containing the carbonate solvent, LiPF₆, and LiPF₂(C₂O₄)₂ is then filled through the fill port. A nonaqueous electrolyte secondary battery in which the negative electrode sheet 60 is coated with the above-described granules can be produced by having the filled nonaqueous electrolyte solution contain these components and by proceeding through the second step, infra. The concentration of the LiPF₆ in the nonaqueous electrolyte solution is desirably at least 0.7 mol/L and not more than 1.3 mol/L. The concentration of the LiPF₂(C₂O₄)₂ in the nonaqueous electrolyte solution is desirably at least 0.005 mol/L, more desirably at least 0.008 mol/L, and even more desirably at least 0.01 mol/L. On the other hand, the concentration of the LiPF₂(C₂O₄)₂ in the nonaqueous electrolyte solution is desirably not more than 1 mol/L, more desirably not more than 0.5 mol/L, and even more desirably not more than 0.1 mol/L. After the nonaqueous electrolyte solution has been filled, the fill port is sealed, thus yielding a lithium ion secondary battery assembly.

The second step is described in the following. The lithium ion secondary battery assembly yielded by the first step is subjected to initial charging at a current of 0.026 C to 0.78 C. This step can be carried out, for example, using known charging devices.

The lithium ion secondary battery 100 in which the surface of the negative electrode 60 is coated with the aforementioned granules can be obtained by subjecting the lithium ion secondary battery assembly containing the nonaqueous electrolyte solution that contains a carbonate solvent, LiPF₆, and LiPF₂(C₂O₄)₂, to an initial charging at a current of 0.026 C to 0.78 C. Here, 1 C denotes the current value that can in one hour charge the battery capacity (Ah) predicted from the theoretical capacity of the positive electrode.

When the current value during the initial charging is smaller than 0.026 C, the average diameter of the approximately circular bases of the granules is then less than 54 nm and lithium metal will readily precipitate on the negative electrode 60. As a result, the capacity will decline when the lithium ion secondary battery is subjected to repeated charge/discharge under conditions that facilitate the production of lithium metal on the negative electrode. When, on the other hand, the current value during the initial charging exceeds 0.78 C, the average diameter of the approximately circular bases of the granules is then larger than 158 nm and lithium metal will readily precipitate on the negative electrode 60. As a result, the capacity will decline when the lithium ion secondary battery is subjected to repeated charge/discharge under conditions that facilitate the production of lithium metal on the negative electrode.

The lithium ion secondary battery 100 constructed proceeding as described above can be used in various applications. A favorable application is as a drive power source mounted in a vehicle such as an electric vehicle (EV), hybrid vehicle (HV), plug-in hybrid vehicle (PHV), and so forth. The lithium ion secondary battery 100 can also be used typically in the form of a battery pack in which a plurality are connected in series or parallel.

A prismatic lithium ion secondary battery 100 provided with a flat wound electrode assembly 20 has been described as an example. However, the herein disclosed lithium ion secondary battery may be provided with a laminate electrode assembly. In addition, the herein disclosed lithium ion secondary battery can also be constructed as a cylindrical lithium ion secondary battery.

The present teaching is described in the following using examples, but the present teaching is not limited to or by these examples.

### Fabrication of the Lithium Ion Secondary Battery Assembly

LiNi_{1/3}Mn_{1/3}Co_{1/3}O₂ (LNCM) as the positive electrode active material, acetylene black (AB) as conductive material, and polyvinylidene fluoride (PVDF) as binder were introduced into a kneader so as to provide a mass ratio among these materials of LNCM:AB:PVDF=90:8:2, and kneading was carried out while adjusting the viscosity with N-methyl-2-pyrrolidone (NMP) to prepare a positive electrode active material slurry. This slurry was coated on both sides of aluminum foil (positive electrode current collector), followed by drying and then pressing to fabricate a positive electrode sheet having a positive electrode active material layer on both sides of the positive electrode current collector.

Natural graphite (C) as the negative electrode active material, styrene-butadiene rubber (SBR) as binder, and carboxymethyl cellulose (CMC) as dispersing agent were introduced into a kneader so as to provide a mass ratio among these materials of C:SBR:CMC=98:1:1, and kneading was carried out while adjusting the viscosity with deionized water to prepare a negative electrode active material slurry. This slurry was coated on both sides of a copper foil (negative electrode current collector), followed by drying and then pressing to fabricate a negative electrode sheet having a negative electrode active material layer on both sides of the negative electrode current collector.

A flat wound electrode assembly was fabricated by laminating the positive electrode sheet and negative electrode sheet fabricated as described above together with two separator sheets (here, a porous sheet in which polypropylene (PP) is laminated on both sides of polyethylene (PE)), winding the laminate, and pressing the resultant flat from the side direction. The positive electrode terminal and negative electrode terminal were connected to this wound electrode assembly followed by housing in a prismatic battery case having an electrolyte solution fill port.

After establishing reduced pressure within the battery case, the nonaqueous electrolyte solution was introduced through the electrolyte solution fill port and the nonaqueous electrolyte solution was permeated into the wound electrode assembly. The nonaqueous electrolyte solution used was prepared by dissolving LiPF₆ at a concentration of 1.0 mol/L as the supporting salt and LiPF₂(C₂O₄)₂ at a concentration of 0.05 mol/L in a mixed solvent that contained ethylene carbonate (EC), dimethyl carbonate (DMC), and ethyl methyl carbonate (EMC) at a volume ratio of EC:DMC:EMC=30:40:30. The electrolyte solution fill port was then sealed to obtain the lithium ion secondary battery assembly.

### Fabrication of the Lithium Ion Secondary Battery

Using the current values given in Table 1, initial charging was carried out on the thusly fabricated lithium ion secondary battery assembly to fabricate lithium ion secondary batteries No. 1 to No. 8. The fabricated lithium ion secondary batteries were evaluated as follows.

### Measurement of Initial Capacity

After carrying out an ageing process on the lithium ion secondary batteries No. 1 to No. 8, the initial capacity was measured in accordance with the following procedure 1 to procedure 3 at a temperature of 25° C. in the voltage range from 3.0 V to 4.1 V.

(Procedure 1) After reaching 3.0 V by constant-current discharge at 1 C, discharge is carried out for 2 hours by constant-voltage discharge; then pause for 10 minutes.

(Procedure 2) After reaching 4.1 V by constant-current charging at 1 C, charging is carried out for 2.5 hours by constant-voltage charging; then pause for 10 minutes.

(Procedure 3) After reaching 3.0 V by constant-current discharge at 1 C, discharge is carried out for 2 hours by constant-voltage discharge; then pause for 10 minutes.

The initial capacity was taken to be the discharge capacity (CCCV discharge capacity) for discharge in procedure 3 running from the constant-current discharge to the constant-voltage discharge.

### Lithium Precipitation Test

After the measurement of the initial capacity, lithium ion secondary batteries No. 1 to No. 8 were adjusted to a state of charge of 50% SOC in a 25° C. environment. A square-wave cycle test was carried out on the batteries for 1000 cycles in a −10° C. environment using the pulse charging pattern of the following steps 1 and 2.

(Step 1) Carry out pulse charging for 5 seconds at a constant current of 25 C; pause for 5 minutes.

(Step 2) Carry out pulse discharge for 5 seconds at a constant current of 25 C; pause for 5 minutes.

The discharge capacity (capacity after pulse test) was measured under the same conditions as for the initial capacity, and their ratio “(capacity after pulse test/initial capacity)×100” was calculated to give the capacity retention ratio after the lithium precipitation test.

### Measurement of the Average Diameter of the Approximately Circular Bases of the Granules on the Negative Electrode

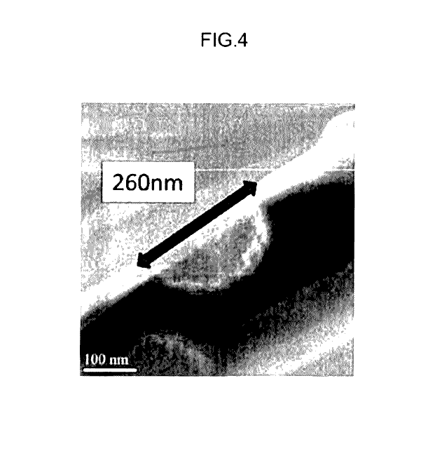

After the measurement of the initial capacity, lithium ion secondary batteries No. 1 to No. 8 were disassembled and cross-sectional samples of the negative electrodes were prepared by air-isolated FIB. TEM photographs (field of view=10 μm×10 μm) of these samples were taken using a field-emission transmission electron microscope (JEM2100F, manufactured by JEOL Ltd.). The photographic conditions were an acceleration voltage of 200 kV and a beam diameter of about 1.0 nmØ. The formation of granules on the negative electrode was confirmed on each TEM photograph for lithium ion secondary batteries No. 1 to No. 8. On each TEM photograph, three negative electrode active materials were investigated and the diameter of the approximately circular bases of ten granules per one negative electrode active material was measured. The average diameter was determined by calculating the average value of the diameters of the approximately circular bases of the total of 30 granules. For reference, the TEM photograph of the cross-sectional sample of the negative electrode for lithium ion secondary battery No. 8 is shown in FIG. 4. The arrow in FIG. 4 shows the segment used as the diameter of the approximately circular base of the granule.

### Component Analysis of the Granules on the Negative Electrode

After the measurement of the initial capacity, lithium ion secondary batteries No. 1 to No. 8 were disassembled and the negative electrodes were removed and TEM-EELS analysis was carried out on the negative electrode surface. The results of the TEM-EELS analysis confirmed that the granules on the negative electrode surface contained element hydrogen, element carbon, element oxygen, element fluorine, and element phosphorus for all of lithium ion secondary batteries No. 1 to No. 8.

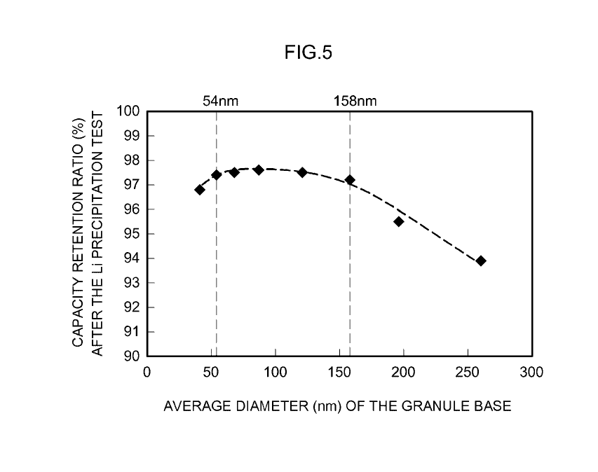

Table 1 gives the evaluation results for lithium ion secondary batteries No. 1 to No. 8 for the capacity retention ratio and the average diameter of the approximately circular bases of the granules on the negative electrode. In addition, FIG. 5 provides a graph, for lithium ion secondary batteries No. 1 to No. 8, of the relationship between the capacity retention ratio and the average diameter of the approximately circular bases of the granules on the negative electrode.

TABLE 1

| | | | Average |
|---|---|---|---|
| | Current value in | Capacity | diameter of |
| | initial charging | retention ratio | the granules |
| Battery No. | (C) | (%) | (nm) |
| 1 | 0.0026 | 96.8 | 41 |
| 2 | 0.026 | 97.4 | 54 |
| 3 | 0.13 | 97.5 | 68 |
| 4 | 0.26 | 97.6 | 87 |
| 5 | 0.4 | 97.5 | 121 |
| 6 | 0.78 | 97.2 | 158 |
| 7 | 1.5 | 95.5 | 196 |
| 8 | 5.26 | 93.9 | 260 |

It was confirmed from these evaluation results that, for all of the lithium ion secondary batteries No. 1 to No. 8, the surface of the negative electrode was coated with granules each having an approximately circular base and these granules contained element hydrogen, element carbon, element oxygen, element fluorine, and element phosphorus. Moreover, it is demonstrated from Table 1 and FIG. 5 that the capacity retention ratio after the lithium precipitation test is particularly high when the average diameter of the approximately circular bases of the granules is in the range from 54 nm to 158 nm. It is also demonstrated that the current value during initial charging should be set to 0.026 C to 0.78 C in order to adjust the average diameter of the approximately circular base of the granules to 54 nm to 158 nm.

Specific examples of the present teaching have been described in detail in the preceding, but these are nothing more than examples and do not limit the claims. Various modifications and alterations of the specific examples provided above as examples are encompassed by the art described in the claims.

What is claimed is:

1. A lithium ion secondary battery comprising:
an electrode assembly having a positive electrode and a negative electrode; and
a nonaqueous electrolyte solution containing a carbonate solvent and LiPF₆, wherein
a surface of the negative electrode is coated with granules each having an approximately circular base,
the granules include element hydrogen, element carbon, element oxygen, element fluorine, and element phosphorus, and
an average diameter of the bases of the granules is 54 nm to 158 nm.

2. A method of producing the lithium ion secondary battery according to claim 1, the method comprising:
fabricating a lithium ion secondary battery assembly including an electrode assembly having a positive electrode and a negative electrode, and a nonaqueous electrolyte solution containing a carbonate solvent, LiPF₆, and LiPF₂(C₂O₄)₂; and
subjecting the lithium ion secondary battery assembly to initial charging at a current of 0.026 C to 0.78 C.
